(19) United States
(12) Patent Application Publication
(10) Pub. No.: US 2003/0060238 A1
(43) Pub. Date: Mar. 27, 2003

(54) Selection function in a communication terminal

(76) Inventors: Kevin McCarthy, Vaerloese (DK); Kim Vejlby Hansen, Farum (DK)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/961,238

(22) Filed: Sep. 25, 2001

(51) Int. Cl. H04M 1/00

(52) U.S. Cl. 455/566; 455/575; 455/563; 455/563

(57) ABSTRACT

The invention concerns a communication terminal having a function for searching available menu items of the menu structure in the communication terminal. The function includes a processor controlling the communication terminal and a user interface through which the user communicates to the processor. The processor also analyses the search criteria entered by a user and presents a list of matching menu items so that the user can select the wanted menu item.

### BACKGROUND OF THE INVENTION

The invention relates to a communication terminal provided with a function for searching in a menu structure of a communication terminal for different functions and features.

In mobile phones is it previously known to have a search function in the phone-book or to have an index, where many functions or features of the mobile phone are listed. The problem with these search tools is they are rather limited in what can be searched. They also have a rather limited function to access the functions from the search tool.

There are also different kinds of short cuts that enable a user to jump directly from standby to the desired function in the communication terminal. The short cuts require the user to remember, where a specific function is located to be able to use the short cut.

### SUMMARY OF THE INVENTION

The claimed invention provides a method for searching menu items in a communication terminal. It also provides a communication terminal having searching means for searching for menu items in the communication terminal.

An object of the invention is to provide a communication terminal having searching means for searching for menu items in the communication terminal so that an inexperienced user can easily locate and execute a function of the communication terminal.

According to a first preferred embodiment of the claimed invention this objective is obtained by a communication terminal having a function for searching available menu items of the communication terminal, and comprising a processor controlling the communication terminal and a user interface through which the user communicates with the processor, a search criteria entered by the user corresponding to the menu item that the user requests access to, an analysis by the processor according to the search criteria when the search criteria input has been finalised by the user, a list of menu items matching the entered search criteria presented to the processor and a function that allows the user to scroll through the presented list of matching menu items and to select the desired menu item to be executed by the processor.

A second object of the invention is to provide a method for searching menu items in a communication terminal so that a user can easily locate and execute a menu item or function of the communication terminal even though the user has little experience of handling communication terminals.

According to a second preferred embodiment of the claimed invention this objective is obtained by a method for searching, presenting and executing available menu items in a communication terminal having a processor controlling the communication terminal and a user interface through which the user communicates with the processor and where the method includes the following step: a user requests access to a menu item, the processor requests the user to enter search criteria, the processor analyses the search criteria when the user indicates that the search criteria input has been finalised, the processor presents a list of menu items matching the entered search criteria; and enables the user to scroll through the presented list of matching menu items and to select the menu item to be executed by the processor.

### BRIEF DESCRIPTION OF THE DRAWING

The invention will be explained more fully below, by way of example, in connection with preferred embodiments and with reference to the drawing, in which:

FIG. 1 shows in a perspective view a known embodiment of a communication terminal.

FIG. 2 schematically shows the essential parts of a telephone for communication with a cellular network.

FIGS. 3-5 shows an idle mode display of communication terminals having different number of soft-keys.

FIG. 6 shows a first embodiment of the invention and different windows of the display of a communication terminal having a search function for searching for menu items according to the invention.

FIG. 7 shows a second embodiment of the invention and different windows of the display of a communication terminal having a search function for searching for menu items according to thin invention.

FIG. 8 shows a third embodiment of the invention and different windows of the display of a communication terminal having a search function for searching for menu items according to the invention.

FIG. 9 shows a flow chart of the search function according to the invention.

### DETAILED DESCRIPTION OF THE INVENTION

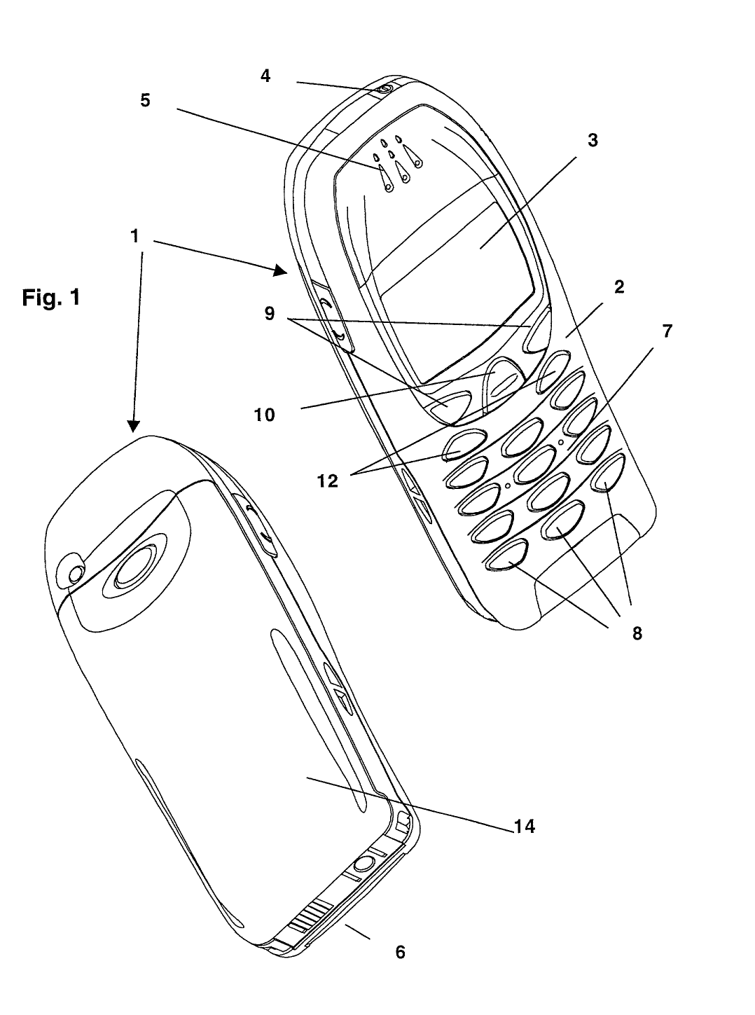

According to a first aspect the search function in a communication terminal according to the invention will be described with reference to a hand portable phone, preferably a cellular/mobile phone. An embodiment of this phone is shown in FIG. 1, where a cellular/mobile phone 1 is shown in perspective. As will be seen, the phone is provided with a front cover 2 having a window frame 3 encircling the protection window of the display assembly 3. The cellular/mobile phone comprises a user interface having an on/off button 4, a speaker 5 (only openings are shown), a keypad 7, a battery 14, a display/LCD 3 and a microphone 6 (only openings are shown).

The keypad 7 has a first group of keys 8 as alphanumeric keys, by means of which the user can enter a telephone number, write a text message (SMS), write a name (associated with the phone number), etc. Each of the twelve alphanumeric keys 8 is provided with a figure “0-9” or a sign “#” or “*”, respectively. In alpha mode each key is associated with a number of letters and special signs used in the text editing.

The keypad 7 additionally comprises two menu selections or soft-keys 9, two call handling keys 12, and a navigation-key 10. The function of the soft-key depends on the state of the phone and the navigation in the menu by using a navigation-key. The present function of the menu selection keys 9 is shown in separate fields in the display 3 just above the keys 9. The two call handling keys 12 are used for establishing a call or a conference call, terminating a call or rejecting an incoming call. This key layout is characteristic of e.g. the Nokia 6210™ phone.

The navigation-key 10 is an up/down key and is placed centrally on the front surface of the phone between the display 3 and the group of alphanumeric keys 8. Hereby the user will be able to control this key with his thumb. This is the best site to place an input key requiring precise motor movements. Many experienced phone users are used to one-hand handling. They place the phone in the hand between the fingertips and the palm of the hand. Hereby the thumb is free for inputting information.

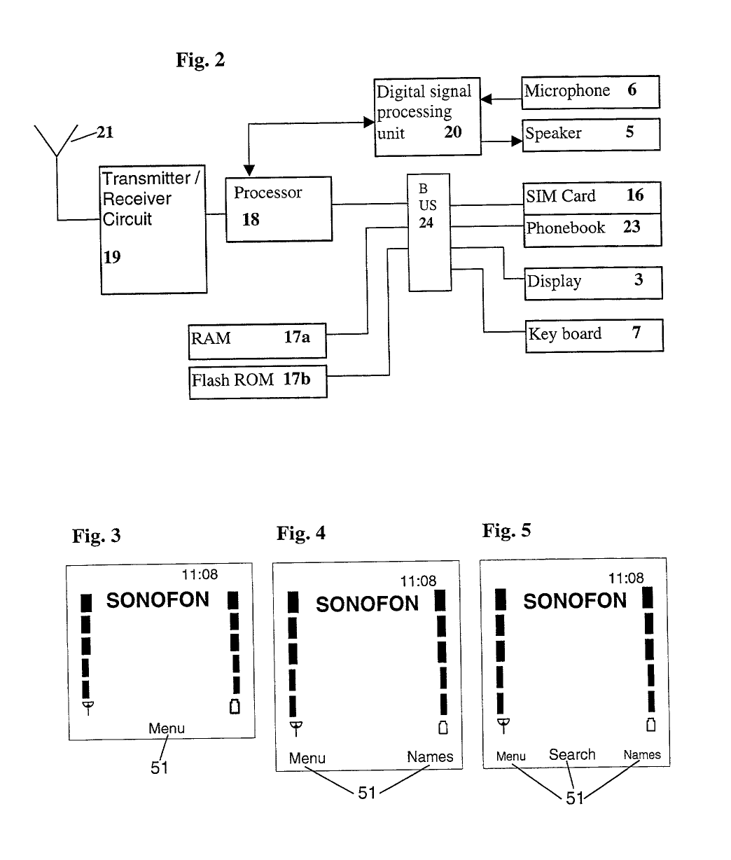

FIG. 2 schematically shows the most important parts of a preferred embodiment of the phone/terminal, said parts being essential to the understanding of the invention. The microphone 6 records the user's speech, and the analogue signals formed thereby are A/D converted in an A/D converter (not shown) before the speech is encoded in an audio part 20. The encoded speech signal is transferred to a processor 18 (physical layer processor), which e.g. supports GSM terminal software. The processor 18 also forms the interface to the peripheral terminals of the apparatus, including RAM and ROM memories 17a and 17b, a SIM card 16, the display 3 and the keypad 7 (from FIG. 1) as well as data, power supply, etc. The processor 18 controls the communication with the network via the transmitter/receiver circuit 19 and an antenna 21. The audio part 20 speech-decodes the signal, which is transferred from the processor 18 to the speaker 5 via a D/A converter (not shown).

The processor 18 is connected via a bus 24 to a RAM memory 17a and a Flash ROM memory 17b, a SIM card 16, the display 3 and the keypad 7 (as well as data, power supply, etc.). Furthermore a phonebook 23 is connected to the processor 18 via the bus 24. The phonebook 23 may be stored on the SIM card 16, and/or in the Flash ROM memory 17a.

The preferred embodiment of the communication terminal of the invention is adapted for use in connection with a GSM network, but, of course, the invention may also be applied in connection with other communication terminal networks. It could be cellular networks, various forms of cordless communication terminal systems or in dual band communication terminals accessing sets of these systems/networks.

The processor 18 is connected to the user interface of the mobile phone. Thus, it is the processor 18, which monitors the activity in the phone and controls the display 3 in response thereto.

Therefore, it is the processor 18, which detects the occurrence of a state change event and changes the state of the phone and thus the display text. The user may cause a state change event, when he/she activates the keypad 7 including the menu selection key or keys 9, and these type of events are called entry events or user events. However, the network communicating with the communication terminal may also cause a state change event. These type of events and other events beyond the user's control are called non-user events. Non user events comprise status change during call set-up, change in battery voltage, change in antenna conditions, message on reception of SMS, etc.

The communication terminal is in idle mode at the start of each embodiment, which means that the communication terminal is turned on and ready to be used for any possible operation. The idle mode display will differ from embodiment to embodiment depending on the set-up of the soft-keys 9. In the embodiments shown the communication terminal has two soft-keys, but the communication terminal can also be provided with one, three or more soft-keys. In FIGS. 3, 4 and 5 is an idle mode display of communication terminals having different number of soft-keys is shown. The other displays (not shown) of the communication terminal having a different number of soft-keys will also be changed accordingly to suit the inventive concept.

The menu structure of the communication terminal can be arranged in many ways, examples of this are a hierarchical tree-structure and a lateral menu structure. In either way the search function will create links to each menu item matching a search criterion entered by the user, but also present a list of menu items matching the search criteria.

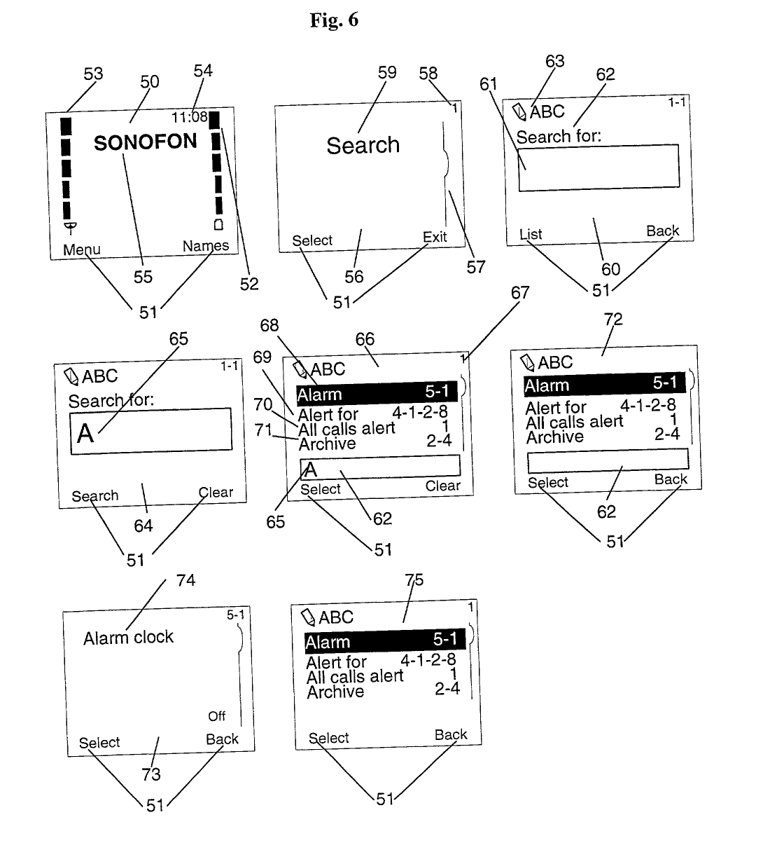

Different embodiments of the invention will be described with reference to FIGS. 6 to 9 showing displays and flow-chart of a communication terminal provided with the search function and with various steps of search function.

In FIG. 6 an idle mode display 50 is shown for the communication terminal or phone 1, which includes two bars indicating the signal strength 53 and the battery level 52. Furthermore there is a time indication 54, an identification 55 of the operator or the network to which the phone 1 is presently connected, and two labels 51 indicating the present function (Menu: access to the Menu structure; Names: access to the Phone book) of the two soft-keys 9.

In a first embodiment of the invention, shown in FIG. 6, is the search function located as one of the menus in the menu structure. In idle mode the user accesses the menu structure by pressing the left soft-key 9 “Menu”, shown in FIG. 6. A new display 56 will appear including a header 59 indicating the mode of the display (“Search”), a menu-level indication 58 in the upper right corner and a picture (not shown) displaying a picture or the like that describes the function of the display menu. If other menus/functions are desired they can be displayed by scrolling down or up with the navigation-key 10 or if the “Search” menu should be located in another place than the first position after idle mode. The menu-level indication 59 indicates the specified number of the menu currently being shown and can be used to short cut the way to that menu without scrolling in the menus with the navigation key 10.

To activate, step 200, the search function the left soft-key 9 “Select” is pressed whilst in display 56, and a display 60 will appear, step 201. The display 60 includes a box 61, wherein a user can enter a search criterion. It also includes a header 62, “Search for:”, indicating what should be entered in the box 62 and a header 63 indicating that entries in the box 62 are in capital letters. The user enters a search criterion, step 202, in the box 62 by pressing the alphanumeric keys 8 that are associated with a number of letters as earlier described. If a voice recognition interface is used the input of the search criterion can be made via voice recognition. The spoken search criterion will be repeated by the communication terminal through the speakers as well as displayed in the box 62. In display 64 an example is shown of an entered search criterion 65 “A”. To use the search criterion 65 in a search the input should first be finalised, step 203. There are several options of how the input can be finalised. The first option is that the user finalises the input, step 203, and activates the search by pressing the left soft-key 9 “Search”, step 204. The second option is that the user finalises the input, step 203, and activates the search by using voice activation, step 205. The third option is that the communication terminal has been set to trigger a timer so that the input is finalised, step 203 and the search is activated after a certain time has elapsed, step 205, after the user has entered the search criterion, step 202.

After the search has been activated step 204, 205 or 206 the processor 18 will analyse the search criterion, step 207 and present a list of menu items matching the search criterion, step 208. An example of this is shown in display 66 having a list of menu items 68-71 matching the search criterion 65 in box 62. A box 62 with the search criterion 65 is also shown in display 66 as well as an order indication number 67 of the menu items in the matching list. In display 66 only four menu items 68-71 are shown, but by using the navigation-key 10 the user can scroll up and down in the matching list to see what other matching menu items were found with the selected search criterion 65. If the user finds the menu item that is wanted/sought this can be selected/executed by pressing the left soft-key 9, step 209, when the desired menu item is highlighted. The communication terminal is thereafter brought to the selected menu item, where the menu item can be started, step 211. An example of a selected menu item is shown in display 73. If the user wishes to change his selection in the display of a selected menu item he can press the right soft-key 9 “Back” and the communication terminal is brought back to display 66 with the matching list, step 212.

If the user finds out that the desired menu item is not in the matching list he can add search criteria to the box 62, step 210, by using the alphanumeric keys 8. The user can also erase the entered search criteria by pressing the right soft-key 9 “Clear” until the box 62 is empty and thereafter enter a new search criterion, step 210. The processor 18 will analyse the new search criterion, step 207, and present the result in the display, step 208, as soon as new input is entered into the box 62. If the box 62 is cleared from search criteria the last selection will be present in the display and all menu items be available, when scrolling up or down in the matching list with the navigation-key 10. If the user presses the right soft-key 9 “Back” when the box 62 is cleared as shown in display 72 the terminal will be brought back to display 60, step 213. Yet another pressing on the right soft-key 9 “Back” and the terminal is brought back to display 56 and the search function is ended.

The search function has another timer so that if no search criterion is entered into the box 62 as shown in display 72 the box 62 will be removed from the display 72 and the display will appear as shown in display 75. If any of the alphanumeric keys 8 are used again the box 62 will appear again with the new search criterion in the box 62 and a list of matching menu items presented.

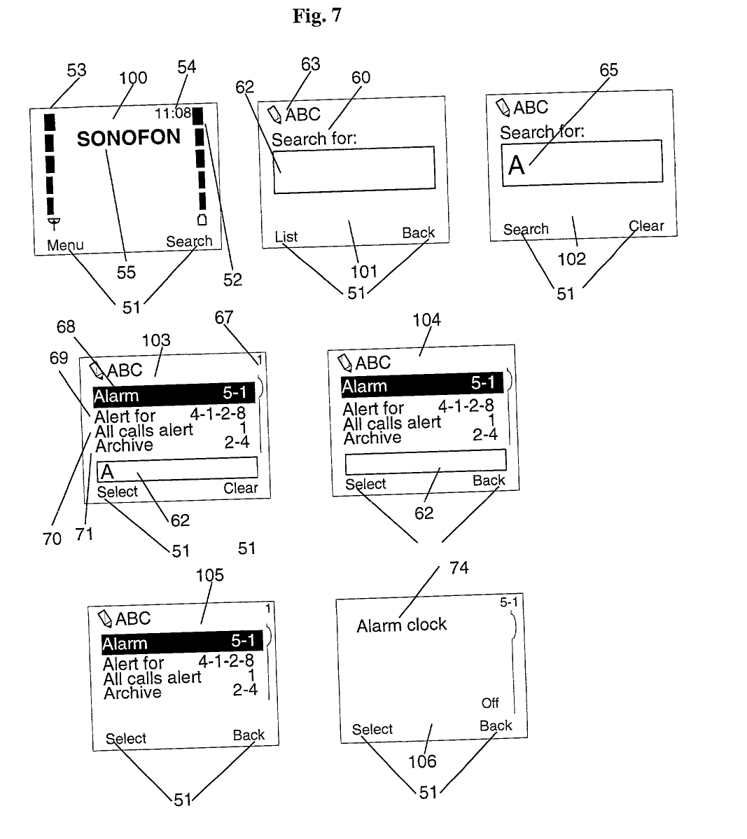

In FIG. 7, display 100 is a second embodiment shown, where the search function is accessible directly from idle mode by pressing the right soft-key 9 “Search”, step 200. The other displays 101-106 shown in FIG. 7 corresponds to the displays shown in connection with the first embodiment. The only major difference between the two embodiments consists in how the search function is accessed and ended.

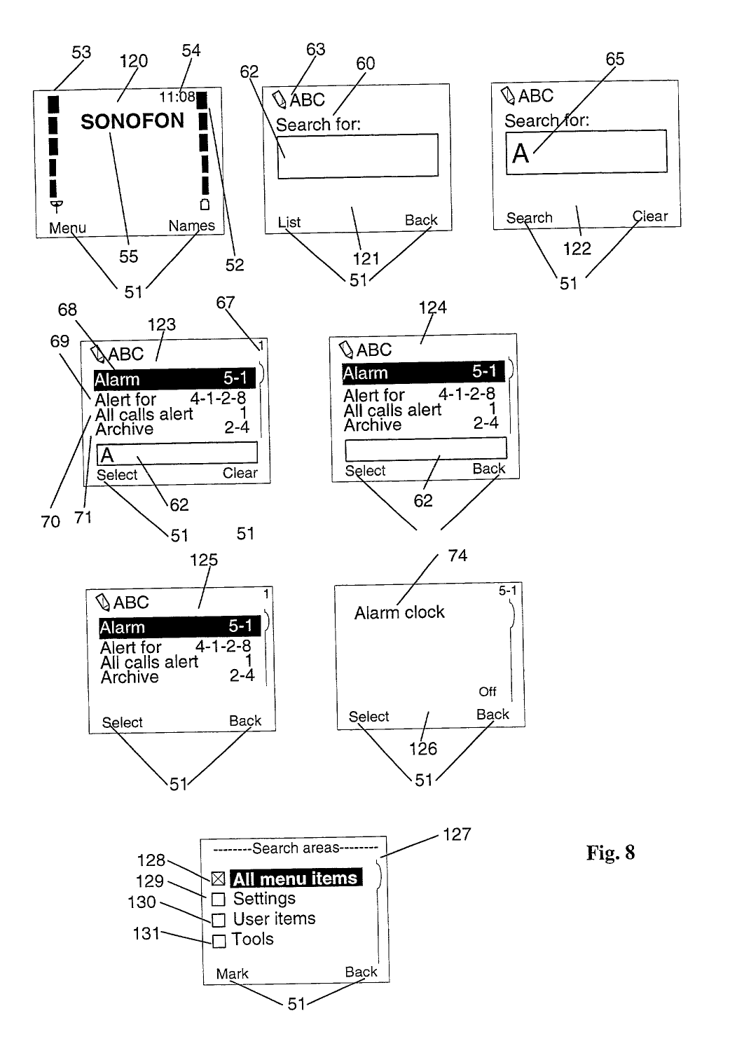

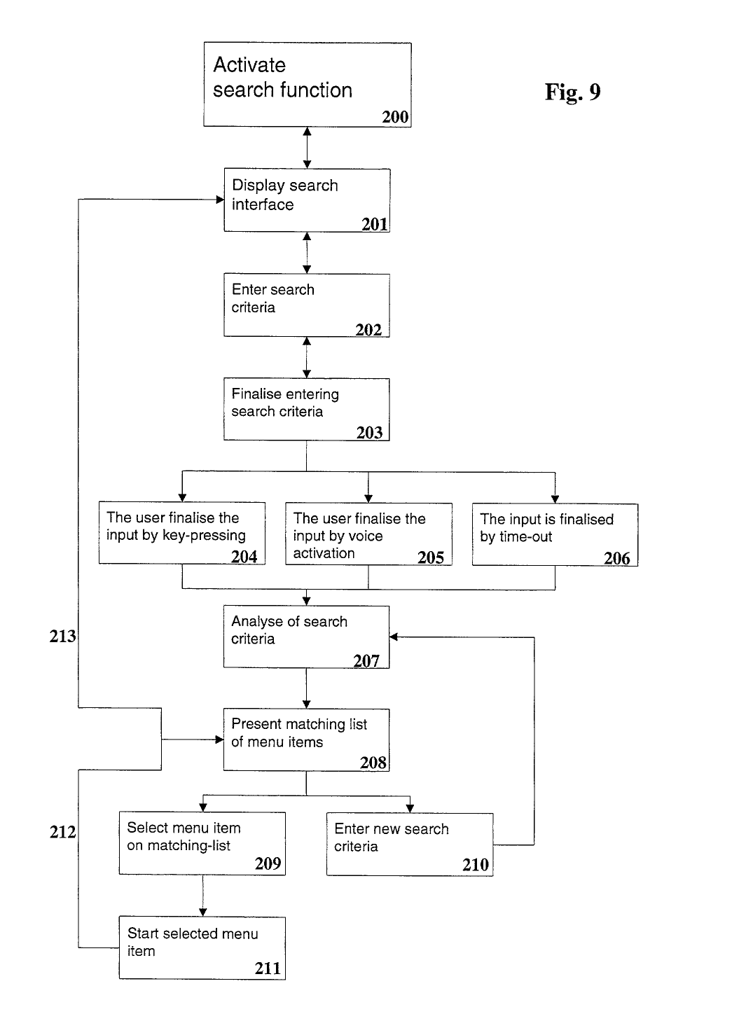

In FIG. 8 a third embodiment is shown, where the search function is accessible directly from idle mode by pressing up or down with the navigation-key 10, step 200. The other displays 121-126 shown in FIG. 8 corresponds to the displays shown in connection with the first embodiment. The only major difference between the two embodiments consists in how the search function is accessed and ended.

In FIG. 8 a fourth embodiment is also shown, display 127, where the user has an opportunity to set the search function to limit the search or selection to certain areas 128-131 of the menu structure. This can be useful if the menu structure includes huge amount of menu items so that the search needs to be restricted to present a perspicuous result.

The invention is not limited to the above-described examples or to the drawings showing examples of an embodiment, but can be varied within the scope of the appended claims.

What is claimed is:

1. A communication terminal having a function for searching available menu items of said communication terminal, and where said function comprise:
a processor controlling said communication terminal and a user interface through which the user communicates with said processor;
said processor requests the user to enter search criteria, when the user requested a menu item access;
said processor analyses the search criteria when the user indicates that the search criteria input has been finalised;
said processor presents a list of menu items matching the entered search criteria; and
enabling the user to scroll through the presented list of matching menu items and to select said menu items for being executed by the processor.

2. A communication terminal having a function for searching available menu items of said communication terminal according to claim 1, wherein the user input is presented in a dialog box on the communication terminal.

3. A communication terminal having a function for searching available menu items of said communication terminal according to claim 2, wherein the input is characters.

4. A communication terminal having a function for searching available menu items of said communication terminal according to any preceding claim, wherein the input to the processor is made via a keypad.

5. A communication terminal having a function for searching available menu items of said communication terminal according to any preceding claim, wherein the input to the processor is made via voice input.

6. A method for locating, displaying and accessing functions in a communication terminal wherein the method includes the following steps:
entering an input in a search function;
displaying a list of menu functions corresponding to said input in the communication terminal display; and
enabling access to the list of menu functions displayed in the communication terminal display.

7. A method for locating, displaying and accessing functions in a communication terminal according to claim 6, wherein the functions are arranged alphabetically to be searched and accessed from one menu.

8. A method for locating and accessing functions in a communication terminal according to claim 7, wherein the functions in all menus are arranged alphabetically to be searched and accessed from one menu.

9. A method for searching, presenting and executing available menu items in a communication terminal having a processor controlling said communication terminal and a user interface through which the user communicates with said processor wherein the method includes the following steps:
said user requesting access to a menu item;
said processor demanding the user to enter search criteria;
said processor analysing the search criteria when the user indicates that the search criteria input has been finalised;
said processor presenting a list of menu items matching the entered search criteria; and
enabling the user to scroll through the present list of matching menu items and selecting of said menu items for being executed by the processor.

10. A method searching, presenting and executing available menu items in a communication terminal according to claim 9, wherein the menu items are arranged alphabetically to be searched and executed from one menu.

11. A method searching, presenting and executing available menu items in a communication terminal according to claim 10, wherein the menu items in all menus are arranged alphabetically to be searched and executed from one menu.

12. A method searching, presenting and executing available menu items in a communication terminal according to claim 9, wherein the finalisation of the user input can be made by a timer.

13. A method searching, presenting and executing available menu items in a communication terminal according to claim 9, wherein the finalisation of the user input can be made by the user that presses a key on the communication terminal.

14. A method searching, presenting and executing available menu items in a communication terminal according to claim 9, wherein the finalisation of the user input can be made by the user that uses voice activation to finalise the input.
